(19) United States
(12) Patent Application Publication
(10) Pub. No.: US 2025/0077581 A1
(43) Pub. Date: Mar. 6, 2025

(54) SYSTEM AND METHOD FOR DYNAMICALLY RECOMMENDING A SET OF POTENTIAL COURSES OF ACTIONS FOR A USER WITHIN A SEARCH QUERY

(71) Applicant: AI Netomi, Inc, San Mateo, CA (US)

(72) Inventors: Suchitra Gupta, Westport, CT (US); Nishant Pandey, Toronto (CA); Rohit Handa, Brampton (CA); Radha Kumari Yadav, Jaipur (IN); Puneet Mehta, San Mateo, CA (US); Dhaval Vipin Mehta, Morrisville, NC (US)

(21) Appl. No.: 18/460,735

(22) Filed: Sep. 5, 2023

(51) Int. Cl. G06F 16/9032; G06N 3/0475

(52) U.S. Cl. CPC G06F 16/90324; G06N 3/0475

(57) ABSTRACT

A system and method for dynamically recommending set of potential courses of actions for a user within a search query are disclosed. The system receives search queries from a user and determines dialogue attributes and context variables based on these queries. It identifies query parameters and additional parameters, The system analyzes user preferences, and determines entities and variants based on the user's preferences and the conversation context. The system then determines the types of set of potential courses of actions to generate for the search queries. Further, the system retrieves set of potential courses of, associated applications, and integration parameters from databases based on the determined types. Using large language models (LLMs) in generative AI or conversation AI environments, the system generates responses and clickable elements corresponding to the search queries, incorporating the recommended set of potential courses of actions, applications, and deep integration parameters.

### TECHNICAL FIELD

Embodiments of the present disclosure generally relate to conversational artificial intelligence (AI) systems and more particularly relates to a system and a method for dynamically recommending a set of potential courses of actions (i.e., next best actions (NBAs)) that user may choose from, within a search query in at least one of a generative artificial intelligence (AI) environment, and a conversation AI environment.

### BACKGROUND

Generally, large language models (LLMs) provide conversational interaction, enabling users to ask follow-up questions and engage in natural and interactive conversations. The conversational interaction enables users to perform conversational search, where users can ask follow-up questions within a search interface, emulating a conversation with the system. This conversation-like interaction allows users to seek clarification, delve deeper into a topic, or explore related information seamlessly. As a result, users are not limited to a single search query, however, can have an ongoing dialogue with the system, similar to conversing with a human assistant. However, LLMs need to accurately comprehend the context and intent behind user queries, especially in conversational search scenarios where users can ask follow-up questions. There can be instances where user queries are misinterpreted, leading to incorrect or incomplete responses. Bridging the gap between machine understanding and human-level comprehension remains a challenge.

Consequently, there is a need for an improved system and a method for dynamically recommending a set of potential courses of actions (i.e., next best action (NBA)) that a user may choose from, within a search query in at least one of a generative artificial intelligence (AI) environment, and a conversation AI environment, to address at least the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a computer-implemented system for dynamically recommending a set of potential courses of actions for a user, within a search query. The system receives one or more search queries from a user associated with a user profile, in at least one of a generative artificial intelligence (AI) environment, and a conversation AI environment. Further, the system determines dialogue attributes based on receiving one or more search queries. Furthermore, the system determines context variables for the one or more search queries, based on the determined dialogue attributes. Additionally, the system identifies one or more query parameters and additional query parameters related to the one or more query parameters, based on the determined context variables. Further, the system analyzes user preferences for the user profile, based on the identified one or more query parameters and additional query parameters. Furthermore, the system determines one or more entities and variants corresponding to the one or more entities, within the context of a conversation corresponding to the one or more search queries, based on the analyzed user preferences. Additionally, the system determines one or more types of one or more recommending a set of potential courses of actions to be generated for the one or more search queries. Further, the system retrieves, from one or more databases, the one or more recommending a set of potential courses of actions, one or more applications and deep integration parameters associated with the one or more recommending the set of potential courses of actions, based on the determined one or more types of the one or more recommending the set of potential courses of actions. Furthermore, the system generates one or more responses and one or more clickable elements corresponding to the one or more search queries, using one or more large language models (LLMs), based on the retrieved the one or more recommending the set of potential courses of actions for the user, the one or more applications and the deep integration parameters. The LLMs are associated with at least one of a generative artificial intelligence (AI) environment, and a conversation AI environment.

Another aspect of the present disclosure provides a method for computer-implemented method for dynamically recommending a set of potential courses of actions within a search query. The method includes receiving one or more search queries from a user associated with a user profile, in at least one of a generative artificial intelligence (AI) environment, and a conversation AI environment. Further, the method includes determining dialogue attributes based on receiving one or more search queries. Furthermore, the method includes determining context variables for the one or more search queries, based on the determined dialogue attributes. Additionally, the method includes identifying one or more query parameters and additional query parameters related to the one or more query parameters, based on the determined context variables. Further, the method includes analyzing user preferences for the user profile, based on the identified one or more query parameters and additional query parameters. Furthermore, the method includes determining one or more entities and variants corresponding to the one or more entities, within the context of a conversation corresponding to the one or more search queries, based on the analyzed user preferences. Additionally, the method includes determining one or more types of one or more recommending the set of potential courses of actions to be generated for the one or more search queries. Further, the method includes retrieving, from one or more databases, the one or more recommending the set of potential courses of actions, one or more applications and deep integration parameters associated with the one or more recommending the set of potential courses of actions, based on the determined one or more types of the one or more recommending the set of potential courses of actions. Furthermore, the method includes generating one or more responses and one or more clickable elements corresponding to the one or more search queries, using one or more large language models (LLMs), based on the retrieved the one or more recommending the set of potential courses of actions for the user, the one or more applications and the deep integration parameters. The LLMs are associated with at least one of a generative artificial intelligence (AI) environment, and a conversation AI environment.

Yet another aspect of the present disclosure provides non-transitory computer-readable storage medium having programmable instructions stored therein. That when executed by one or more hardware processors, cause the one or more hardware processors to receive one or more search queries from a user associated with a user profile, in at least one of a generative artificial intelligence (AI) environment, and a conversation AI environment. The one or more hardware processors determine dialogue attributes based on receiving one or more search queries. Further, the one or more hardware processors determine context variables for the one or more search queries, based on the determined dialogue attributes. Furthermore, the one or more hardware processors identify one or more query parameters and additional query parameters related to the one or more query parameters, based on the determined context variables. Further, the one or more hardware processors analyze user preferences for the user profile, based on the identified one or more query parameters and additional query parameters. Additionally, the one or more hardware processors determine one or more entities and variants corresponding to the one or more entities, within the context of a conversation corresponding to the one or more search queries, based on the analyzed user preferences. Further, the one or more hardware processors determine one or more types of one or more recommending a set of potential courses of actions to be generated for the one or more search queries. Furthermore, the one or more hardware processors retrieve, from one or more databases, the one or more recommending the set of potential courses of actions, one or more applications and deep integration parameters associated with the one or more recommending the set of potential courses of actions, based on the determined one or more types of the one or more recommending the set of potential courses of actions. Additionally, the one or more hardware processors generate one or more responses and one or more clickable elements corresponding to the one or more search queries, using one or more large language models (LLMs), based on the retrieved the one or more recommending the set of potential courses of actions, the one or more applications and the deep integration parameters. The LLMs are associated with at least one of a generative artificial intelligence (AI) environment, and a conversation AI environment.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1 illustrates an exemplary block diagram representation of a network architecture implementing a system for dynamically recommending a set of potential courses of actions for a user, within a search query, in accordance with an embodiment of the present disclosure;

FIG. 2 illustrates an exemplary block diagram representation of a computer-implemented system, such as those shown in FIG. 1, capable of dynamically recommending a set of potential courses of actions for a user, within a search query, in accordance with an embodiment of the present disclosure;

FIG. 3A illustrates an exemplary block diagram representation of logical data model for dynamically recommending a set of potential courses of actions for a user, within a search query, in accordance with an embodiment of the present disclosure;

FIG. 3B illustrates an exemplary block diagram representation of a search system architecture, in accordance with an embodiment of the present disclosure;

FIG. 3C illustrates an exemplary block diagram representation of artificial intelligence (AI) model for dynamically recommending a set of potential courses of actions within a search query, in accordance with an embodiment of the present disclosure;

FIGS. 4A and 4B illustrate exemplary schematic diagram representations of scenarios for dynamically recommending a set of potential courses of actions within a search query, in accordance with an embodiment of the present disclosure;

FIG. 5 illustrates a flow chart depicting a method of dynamically recommending a set of potential courses of actions for a user, within a search query, in accordance with the embodiment of the present disclosure; and

FIG. 6 illustrates an exemplary block diagram representation of a hardware platform for implementation of the disclosed system, according to an example embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client, or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Embodiments of the present disclosure provide a system and a method for dynamically recommending a set of potential courses of actions (next best actions (NBAs)), for a user, within a search query in at least one of a generative artificial intelligence (AI) environment, and a conversation AI environment. When more than one NBAs are recommended the NBAs may be independent, and the NBAs are offered to the user to decide which action the user may need to choose. The present disclosure uses a combination of large language models (LLMs) and neural network (NN) models to provide a conversational search experience with a recommending the set of potential courses of actions (e.g., next best actions (NBAs)) support. Further, the present disclosure enhances user experience, by offering a combination of short responses, relevant links, and recommending the set of potential courses of actions application links, in turn a conversational search experience is significantly improved. Users can seamlessly navigate to relevant applications without the need to search for them manually, resulting in a more streamlined and efficient user experience. The integration of recommending the set of potential courses of actions application links within the search interface makes it a central point for users to discover and access applications within an enterprise. Users can explore various applications in the context of their query, leading to better application awareness and utilization. Further, relevant information from the search and conversation history is automatically passed along to the recommending the set of potential courses of actions (NBAs) applications. This eliminates the need for users to re-enter the same information within the application, saving time and effort while providing a seamless user experience.

Further, the present disclosure supports single sign-on (SSO) ensuring a smooth transition for users when redirected to a recommending the set of potential courses of actions (NBAs) application. Users are not required to log in again, enhancing convenience and eliminating potential friction points. Further, decoupling search pages and application links through recommending the set of potential courses of actions allows for segregation of duties within an organization. Different groups can independently manage search and recommending the set of potential courses of actions applications, ensuring efficient management and maintenance of the system components. The present disclosure enables recording of the entire conversation history, including queries, text, relevant links, responses, and user click-through activity, in a search database for powerful search analytics and user journey mapping. This data can be utilized to gain insights into user behavior, improve search performance, and understand user interactions across the enterprise application ecosystem. The dynamic recommending the set of potential courses of actions (NBAs) application discovery is not limited to search interactions alone. It can also be extended to other user interactions, such as chat conversations, where application links can be offered to assist users or provide up-selling and cross-selling opportunities based on user intent.

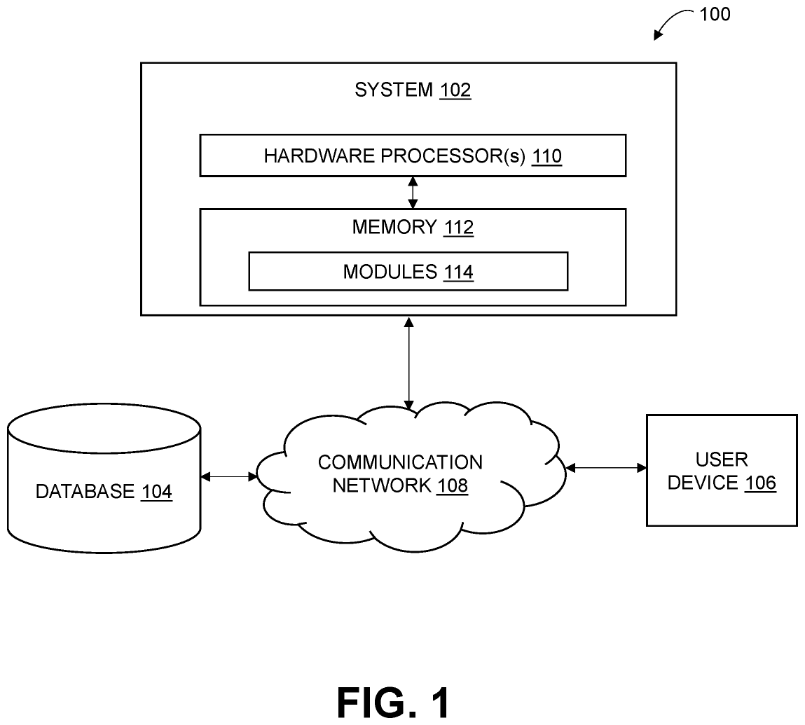

Referring now to the drawings, and more particularly to FIG. 1 through FIG. 6, where similar reference characters denote corresponding features consistently throughout the figures, there are shown preferred embodiments and these embodiments are described in the context of the following exemplary system and/or method.

FIG. 1 illustrates an exemplary block diagram representation of a network architecture 100 implementing a system 102 for dynamically recommending a set of potential courses of actions (next best actions (NBAs)) for a user, within a search query, in accordance with an embodiment of the present disclosure. According to FIG. 1, the network architecture 100 may include the system 102, a database 104, and a user device 106. The system 102 may be communicatively coupled to the database 104, and the user device 106 via a communication network 108. The communication network 108 may be a wired communication network and/or a wireless communication network. The database 104 may include, but is not limited to, recommending a set of potential courses of actions, applications, application links, application name, application description, application meta-data, application identifier, display name of the one or more applications, short textual description, a universal resource locator (URL) of the one or more applications, and a list of parameters corresponding to application context, generated recommending the set of potential courses of actions, one or more clickable elements, completion status of initiated user action through recommended the set of potential courses of actions (next best actions (NBAs)), feedback loops, feedback from users, query parameters, additional query parameters, deep integration parameters, up-sell/x-sell product links, tracked user click-through rates, any other data, and combinations thereof. The database 104 may be any kind of database such as, but are not limited to, relational databases, dedicated databases, dynamic databases, monetized databases, scalable databases, cloud databases, distributed databases, any other databases, and combination thereof.

Further, the user device 106 may be associated with, but not limited to, a user, an individual, an administrator, a vendor, a technician, a worker, a specialist, an instructor, a supervisor, a team, an entity, an organization, a company, a facility, a bot, any other user, and combination thereof. The entities, the organization, and the facility may include, but are not limited to, an e-commerce company, a merchant organization, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like. The user device 106 may be used to provide input and/or receive output to/from the system 102, and/or to the database 104, respectively. The user device 106 may present to the user one or more user interfaces for the user to interact with the system 102 and/or to the database 104 for the set of potential courses of actions (NBAs) recommending needs. The user device 106 may be at least one of, an electrical, an electronic, an electromechanical, and a computing device. The user device 106 may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the system 102 may be implemented by way of a single device or a combination of multiple devices that may be operatively connected or networked together. The system 102 may be implemented in hardware or a suitable combination of hardware and software. The system 102 includes one or more hardware processor(s) 110, and a memory 112. The memory 112 may include a plurality of modules 114. The system 102 may be a hardware device including the hardware processor 110 executing machine-readable program instructions for dynamically recommending the set of potential courses of actions for the user within a search query. Execution of the machine-readable program instructions by the hardware processor 110 may enable the proposed system 102 to dynamically recommend the set of potential courses of actions for the user, within a search query. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more hardware processors 110 may include, for example, microprocessors, microcomputers, microcontrollers, digital signal processors, central processing units, state machines, logic circuits, and/or any devices that manipulate data or signals based on operational instructions. Among other capabilities, hardware processor 110 may fetch and execute computer-readable instructions in the memory 112 operationally coupled with the system 102 for performing tasks such as data processing, input/output processing, and/or any other functions. Any reference to a task in the present disclosure may refer to an operation being or that may be performed on data.

Though few components and subsystems are disclosed in FIG. 1, there may be additional components and subsystems which is not shown, such as, but not limited to, ports, routers, repeaters, firewall devices, network devices, databases, network attached storage devices, servers, assets, machinery, instruments, facility equipment, emergency management devices, image capturing devices, any other devices, and combination thereof. The person skilled in the art should not be limiting the components/subsystems shown in FIG. 1. Although FIG. 1 illustrates the system 102, and the user device 106 connected to the database 104, one skilled in the art can envision that the system 102, and the user device 106 can be connected to several user devices located at various locations and several databases via the communication network 108.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

In an exemplary embodiment, the system 102 may receive one or more search queries from a user associated with a user profile, in at least one of a generative artificial intelligence (AI) environment, and a conversation AI environment. For example, the system 102 may analyze the one or more search queries. The analysis of the one or more search queries may entail integrating contextual details, rectifying misspelled words, and handling grammatical errors. These tasks are achieved through prompt-based Large Language Model (LLM) inference. For example, consider a search query such as a “Sullivan park ticket price”, which may be analyzed by the system 102 to rephrase as “price of Sullivan park ticket.” Similarly, the next search query may include “opening time?” may be analyzed by the system 102 to rephrase as “what is the opening time of Sullivan park”.

In an exemplary embodiment, the system 102 may determine dialogue attributes based on receiving one or more search queries. The dialogue attributes include, but are not limited to, a current search query, a historical conversation, additional interactions within a plurality of conversations, and the like. In addition to the current search query and historical conversation, external systems, such as customer relationship management (CRM) system may supply dialogue attributes including user metadata. Examples of the dialogue attributes include, but are not limited to, user tier (basic, premium), geo-location, current subscription status, user preferences, and the like.

In an exemplary embodiment, the system 102 may determine context variables for the one or more search queries, based on the determined dialogue attributes. The context variables may include significant information extracted from the LLMs, derived from the user's message/search query, and conversation history. For example, in a user conversation with two messages as “travelling with a 9 year old kid, what's the ticket price of business class?” and “do you serve Chinese food onboard?”, derived context variables are “age group as kid, age as 9 years, fare class as business class, and cuisine as Chinese”.

In an exemplary embodiment, the system 102 may identify one or more query parameters and additional query parameters related to the one or more query parameters, based on the determined context variables.

In an exemplary embodiment, the system 102 may analyze user preferences for the user profile, based on the identified one or more query parameters and additional query parameters.

In an exemplary embodiment, the system 102 may determine one or more entities and variants corresponding to the one or more entities, within the context of a conversation corresponding to the one or more search queries, based on the analyzed user preferences. The variants corresponding to the one or more entities includes, but are not limited to, synonyms of the one or more entities, abbreviations of the one or more entities, a hierarchy of the one or more entities, and the like.

In an exemplary embodiment, the system 102 may determine one or more types of one or more recommending the set of potential courses of actions (NBAs) to be generated for the one or more search queries. The one or more types of one or more recommending the set of potential courses of actions includes, but are not limited, one or more recommending the set of potential courses of actions (NBAs) without the one or more query parameters, a one or more recommending the set of potential courses of actions with the one or more query parameters, a one or more recommending the set of potential courses of actions with or without deep integration parameters, one or more recommending the set of potential courses of actions driven using a plurality of entry points based on the one or more search queries, and the like.

In an exemplary embodiment, the system 102 may retrieve from one or more databases 104, the one or more recommending the set of potential courses of actions, one or more applications and deep integration parameters associated with the one or more recommending the set of potential courses of actions (NBAs), based on the determined one or more types of the one or more recommending the set of potential courses of actions. The one or more applications retrieved from one or more databases 104 based on, but is not limited to, an application name, application description, application meta-data, application identifier, display name of the one or more applications, short textual description, a universal resource locator (URL) of the one or more applications, a list of parameters corresponding to application context, and the like.

In an exemplary embodiment, the system 102 may generate one or more responses and one or more clickable elements corresponding to the one or more search queries, using one or more large language models (LLMs), based on the retrieved the one or more recommending the set of potential courses of actions (next best actions (NBAs)), the one or more applications and the deep integration parameters. The LLMs are associated with at least one of a generative artificial intelligence (AI) environment, and a conversation AI environment. For example, the LLMs may include, but not limited to, a Falcon-40B-instruct, a Mosaic Pretrained Transformer (MPT-30B), and the like.

In an exemplary embodiment, the system 102 may track user click-through rates on the generated one or more responses and one or more clickable elements corresponding to the one or more search queries. In an exemplary embodiment, the system 102 may create a feedback loop corresponding to the tracked user click-through rates to influence the one or more LLMs to reinforce and generate similar one or more responses and one or more clickable elements corresponding to similar one or more search queries. In an exemplary embodiment, the system 102 may modify the one or more LLMs to both seasonal patterns and user behavior patterns tracked through user click-through rates for the one or more search queries, based on the created feedback loop. The one or more clickable elements may include, but are not limited to, links, descriptions, source of information, directions, maps, website address, universal resource locator (URL), share, like button, dislike button, copy button, alternative links/buttons, and the like.

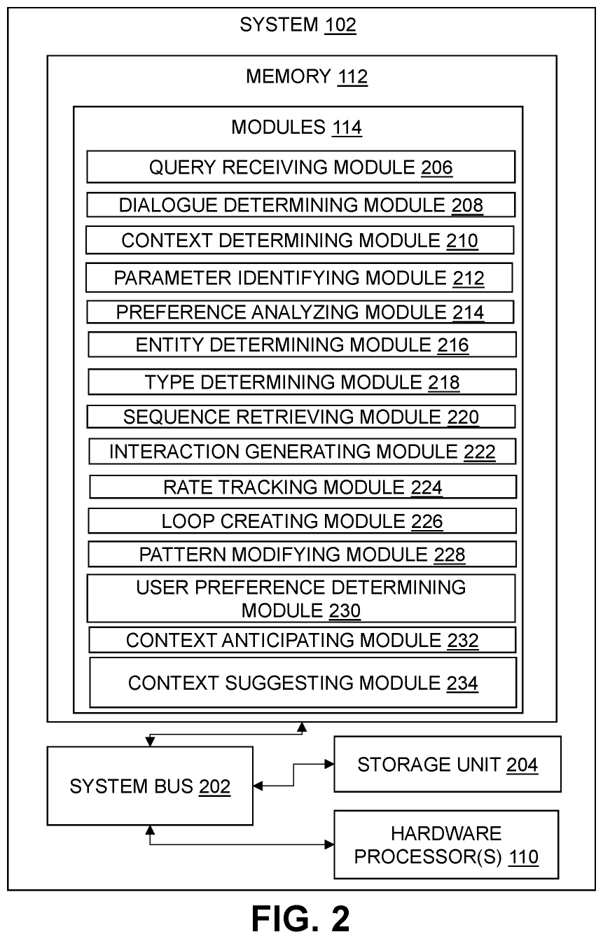

FIG. 2 illustrates an exemplary block diagram representation of a computer-implemented system 102, such as those shown in FIG. 1, capable of dynamically recommending the set of potential courses of actions within a search query, in accordance with an embodiment of the present disclosure. The system 102 may also function as a computer-implemented system (hereinafter referred to as the system 102). The system 102 comprises the one or more hardware processors 110, the memory 112, and a storage unit 204. The one or more hardware processors 110, the memory 112, and the storage unit 204 are communicatively coupled through a system bus 202 or any similar mechanism. The memory 112 comprises a plurality of modules 114 in the form of programmable instructions executable by the one or more hardware processors 110.

Further, the plurality of modules 114 includes a query receiving module 206, a dialogue determining module 208, a context determining module 210, a parameter identifying module 212, an preference analyzing module 214, an entity determining module 216, a type determining module 218, a sequence retrieving module 220, a interaction generating module 222, a rate tracking module 224, a loop creating module 226, a pattern modifying module 228, a user preference determining module 230, an context anticipating module 232, and a context suggesting module 234.

The one or more hardware processors 110, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory 112 may be a non-transitory volatile memory and a non-volatile memory. The memory 112 may be coupled to communicate with the one or more hardware processors 110, such as being a computer-readable storage medium. The one or more hardware processors 110 may execute machine-readable instructions and/or source code stored in the memory 112. A variety of machine-readable instructions may be stored in and accessed from the memory 112. The memory 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory 112 includes the plurality of modules 114 stored in the form of machine-readable instructions on any of the above-mentioned storage media and may be in communication with and executed by the one or more hardware processors 110.

The storage unit 204 may be a cloud storage or a database such as those shown in FIG. 1. The storage unit 204 may store, but is not limited to, recommending the set of potential courses of actions (i.e., next best actions (NBAs)), applications, application links, application name, application description, application meta-data, application identifier, display name of the one or more applications, short textual description, a universal resource locator (URL) of the one or more applications, and a list of parameters corresponding to application context, generated recommending the set of potential courses of actions, one or more clickable elements, completion status of initiated user action through recommended the set of potential courses of actions, feedback loops, feedback from users, query parameters, additional query parameters, deep integration parameters, up-sell/x-sell product links, tracked user click-through rates, any other data, and combinations thereof. The storage unit 204 may be any kind of database such as, but are not limited to, relational databases, dedicated databases, dynamic databases, monetized databases, scalable databases, cloud databases, distributed databases, any other databases, and a combination thereof.

In an exemplary embodiment, the query receiving module 206 may receive one or more search queries from a user associated with a user profile, in at least one of a generative artificial intelligence (AI) environment, and a conversation AI environment.

In an exemplary embodiment, the dialogue determining module 208 may determine dialogue attributes based on receiving one or more search queries. The dialogue attributes include, but are not limited to, a current search query, a historical conversation, additional interactions within a plurality of conversations, and the like.

In an exemplary embodiment, the context determining module 210 may determine context variables for the one or more search queries, based on the determined dialogue attributes.

In an exemplary embodiment, the parameter identifying module 212 may identify one or more query parameters and additional query parameters related to the one or more query parameters, based on the determined context variables.

In an exemplary embodiment, the preference analyzing module 214 may analyze user preferences for the user profile, based on the identified one or more query parameters and additional query parameters.

In an exemplary embodiment, the entity determining module 216 may determine one or more entities and variants corresponding to the one or more entities, within the context of a conversation corresponding to the one or more search queries, based on the analyzed user preferences. The variants corresponding to the one or more entities includes, but are not limited to, synonyms of the one or more entities, abbreviations of the one or more entities, a hierarchy of the one or more entities, and the like.

In an exemplary embodiment, the type determining module 218 may determine one or more types of one or more recommending the set of potential courses of actions to be generated for the one or more search queries. The one or more types of one or more recommending the set of potential courses of actions (NBAs) includes, but are not limited, one or more recommending the set of potential courses of actions without the one or more query parameters, a one or more recommending the set of potential courses of actions with the one or more query parameters, a one or more recommending the set of potential courses of actions with or without deep integration parameters, one or more recommending the set of potential courses of actions driven using a plurality of entry points based on the one or more search queries, and the like.

In an exemplary embodiment, the sequence retrieving module 220 may retrieve from one or more databases 104, the one or more recommending the set of potential courses of actions, one or more applications and deep integration parameters associated with the one or more recommending the set of potential courses of actions, based on the determined one or more types of the one or more recommending the set of potential courses of actions (NBAs). The one or more applications retrieved from one or more databases 104 based on, but is not limited to, an application name, application description, application meta-data, application identifier, display name of the one or more applications, short textual description, a universal resource locator (URL) of the one or more applications, a list of parameters corresponding to application context, and the like.

In an exemplary embodiment, the interaction generating module 222 may generate one or more responses and one or more clickable elements corresponding to the one or more search queries, using one or more large language models (LLMs), based on the retrieved the one or more recommending the set of potential courses of actions, the one or more applications and the deep integration parameters. The LLMs are associated with at least one of a generative artificial intelligence (AI) environment, and a conversation AI environment.

In an exemplary embodiment, the rate tracking module 224 may track user click-through rates on the generated one or more responses and one or more clickable elements corresponding to the one or more search queries. In an exemplary embodiment, the loop creating module 226 may create a feedback loop corresponding to the tracked user click-through rates to influence the one or more LLMs to reinforce and generate similar one or more responses and one or more clickable elements corresponding to similar one or more search queries. In an exemplary embodiment, the pattern modifying module 228 may modify the one or more LLMs to both seasonal patterns and user behavior patterns tracked through user click-through rates for the one or more search queries, based on the created feedback loop. The one or more clickable elements may include, but are not limited to, links, descriptions, source of information, directions, maps, website address, universal resource locator (URL), share, like button, dislike button, copy button, alternative links/buttons, and the like.

In an exemplary embodiment, for determining the one or more type of one or more recommending the set of potential courses of actions (NBAs), the type determining module 218 may determine at least one of an auto-executed type one or more recommending the set of potential courses of actions and a user triggered type of one or more recommending the set of potential courses of actions. Further, the type determining module 218 may retrieve information from the one or more databases 104 to supplement the generated one or more responses, when the determined one or more types corresponds to the auto-executed type one or more recommending the set of potential courses of actions. Furthermore, the type determining module 218 may identify from the one or more databases 104 the one or more recommending the set of potential courses of actions to display to the user for required action, when the determined one or more types corresponds to the user triggered type one or more recommending the set of potential courses of actions.

In an exemplary embodiment, the user preference determining module 230 may determine one or more user preferences from an action on the one or more clickable elements and the one or more search queries. Furthermore, the context anticipating module 232 may anticipate one or more contexts required to execute actions on the one or more clickable elements and the one or more search queries. Additionally, the context suggesting module 234 may suggest one or more contexts when completing actions related to natural language on the one or more clickable elements and the one or more search queries.

In an exemplary embodiment, the sell recommending module (not shown) may recommend at least on one of an up-sell recommending the set of potential courses of actions for the user and a x-sell recommending the set of potential courses of actions for the user, based on a user intent in the determined context variables for the one or more search queries.

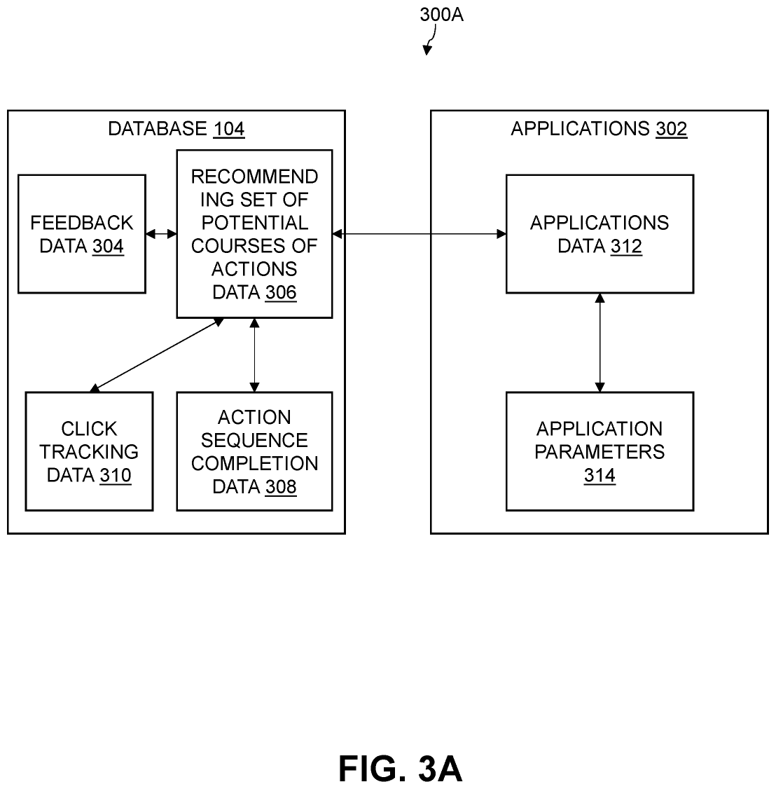

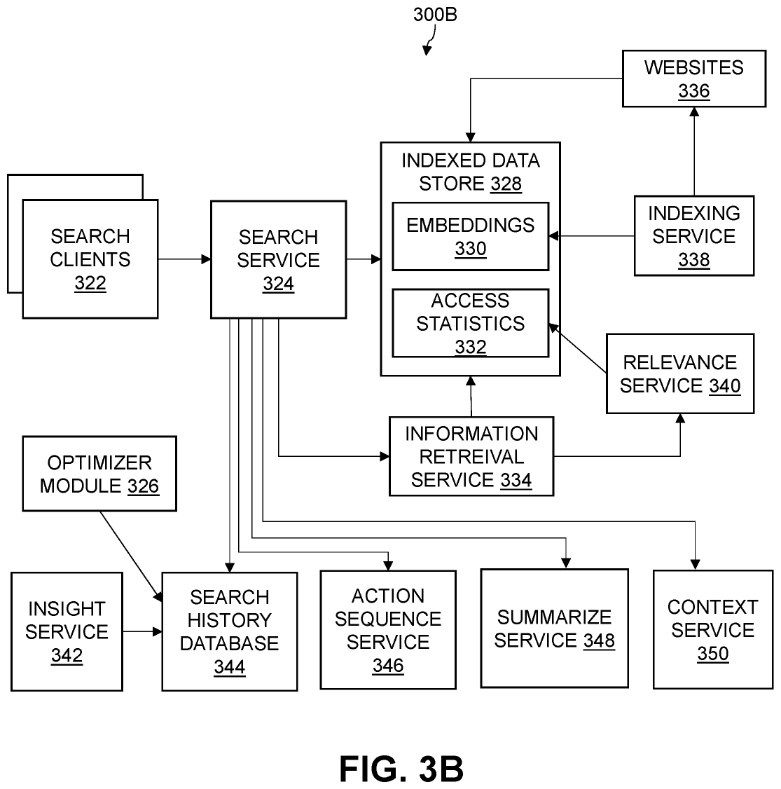

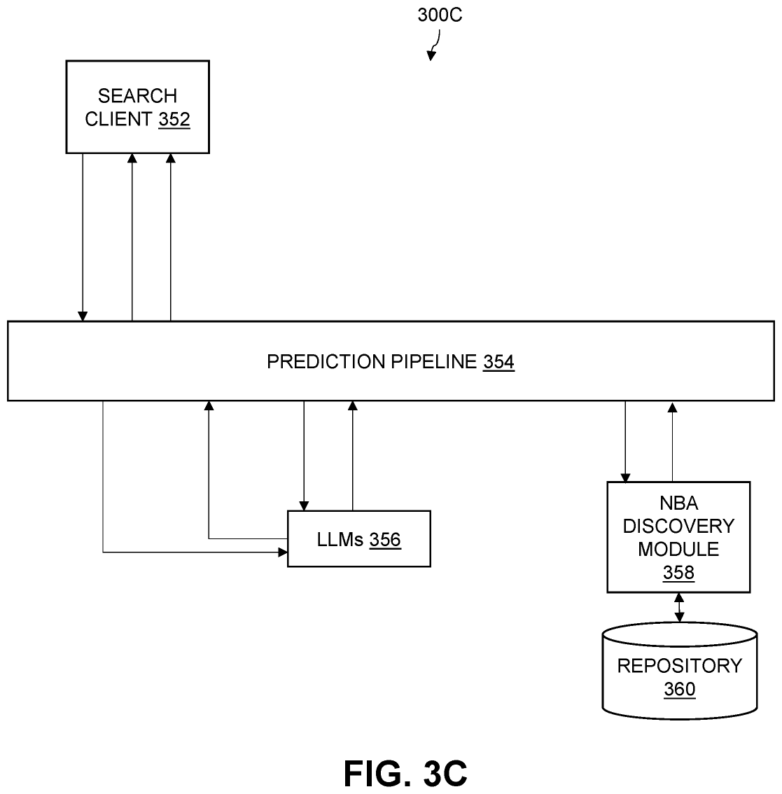

FIG. 3A illustrates an exemplary block diagram representation of logical data model 300A for dynamically recommending the set of potential courses of actions for the user, within a search query, in accordance with an embodiment of the present disclosure.

The database 104 may include the recommending the set of potential courses of actions sequence data 306 generated by the LLMs, along with relevant application attributes such as, but not limited to, application identity (ID), fully formed application universal resource locator (URL), name of recommended set of potential courses of actions name, sources used for generating the recommended set of potential courses of actions for the user, the ranking of the recommended set of potential courses of actions for the user to choose from, and the like. The database 104 may include click tracking data 310, which the user has clicked on clickable elements corresponding to the recommended set of potential courses of actions. For example, the recommended set of potential courses of actions and any other assets presented in search results, when clicked upon by the user, may be stored in the repository along with relevant attributes.

Further, the database 104 may include a completion of initiated user action via recommended set of potential courses of actions click (i.e., action sequence completion data 308). There may be a user action feedback loop from the recommended set of potential courses of actions application to the database 104, to indicate if the user-initiated action via the recommended set of potential courses of actions link was completed or abandoned. This may be used by the recommended set of potential courses of actions generation algorithm in future to rank/select the NBA for similar user queries. Furthermore, the database 104 may include feedback data 304 provided by the users for the recommended set of potential courses of action(s). The clickable elements such as thumbs up/down will allow the search user to indicate relevance of the presented recommended set of potential courses of actions. This may be used by the recommended set of potential courses of actions generation algorithm in future to rank/select the recommended set of potential courses of actions.

Further, applications 302 may include application data 312. The applications 302 may include enterprise/third party applications and parameters 314 for the recommended set of potential courses of actions. This may store enterprise and third-party applications metadata, including but not limited to, application URL, application name, description of what actions the application enables the user to take, the parameters required by each application, the associated data types and other relevant details to successfully navigate the user to the corresponding recommended set of potential courses of actions application.

The key attributes of entities captured in the database 104 may include, but not limited to, the feedback 304 may include, ID, recommended set of potential courses of actions ID, feedback yes/no (YN), and the like, the recommending set of potential courses of actions data 306 may include, ID, name, session ID, query ID, application ID, application URL, short description, sources, the action sequence completion data 308 may include, ID, recommended set of potential courses of actions ID, action completion yes/no (YN), and the click tracking data 310 may include, ID, asset type, asset ID, and the like. The applications 302 may be stored in an application repository (such as the database 104) in which each record consists of the application identifier, display name of the application, short textual description, URL of the application, and the list of parameters it can accept as application context. For example, feedback YN may capture user feedback for the recommended set of potential courses of actions (NBAs). An action of ‘Y’ from the user may be positive i.e., user found the suggested action useful, and ‘N’ may be negative i.e., user does not find the suggested action useful.

FIG. 3B illustrates an exemplary block diagram representation of a search system architecture 300B, in accordance with an embodiment of the present disclosure. According to FIG. 3B, complete range of services and communication involved in the training and prediction phase of search and recommending set of potential courses of actions discovery is shown. In an exemplary embodiment, the system 102 may execute a search clients 322 to establish a connection with a search service 324, which efficiently orchestrates the request among various other services. In an exemplary embodiment, the system 102 may execute an information retrieval service 334 to fetch one or more pertinent documents corresponding to the search query, from an indexed data store 328. The indexed data store 328 may include embeddings 330, and access statistics 332. These indexed documents are stored in a vector store database (not shown), presented as embeddings derived from one or more websites 336 and other sources. The embedding 330 and the websites 336 may be indexed using a indexing service 338. Further, the access statistics 332 may be generated using a relevance service 340, which retrieves information from the information retrieval service 334. Further, a search history database 344 includes one or more user conversation histories which may be used by optimizer module 326 for generating insights using a insight service 342. Additionally, the system 102 may execute a search service 324 to connect with a context service 350 to synthesize the context variables utilized by the action sequence service 346. In an exemplary embodiment, the system 102 may execute the search service 324 to optionally request a summarization, from a summarization service 348, of user conversations based on specific configurations.

FIG. 3C illustrates an exemplary block diagram representation of artificial intelligence (AI) model 300C for dynamically recommending a set of potential courses of actions for a user, within a search query, in accordance with an embodiment of the present disclosure. The AI model 300C may be used for processing user messages. Essential AI services and the corresponding output variables obtained from each service is shown. For initiating the process, a search client 352 may provide the user message and conversation history to LLMs 356. The LLMs 356 then analyzes the data, deriving contextual variables, rephrased search queries, and relevant source URLs. Subsequently, a NBA discovery module 358 utilize this information to predict the most relevant Next Best Actions (NBAs) from a list stored in a NBA repository 360.

The recommended set of potential courses of actions algorithms leverage rich contextual information to make accurate predictions, ensuring that the recommended set of potential courses of actions closely aligns with the user's needs and preferences. Over time, the AI model 300C such as the system 102 may employ an active learning methodology to continuously enhance its recommendations by tracking user click-through rates on the recommended set of potential courses of actions. This creates a feedback loop that influences the AI model's predictions, reinforcing their accuracy and guiding them to make similar potential courses of actions recommendations in similar use-cases. This iterative process allows the system 102 to adapt and learn from user feedback, continuously improving its predictive capabilities and enhancing the user experience. The dynamic active learning methodology enables the system 102 to learn and adapt to seasonal patterns and user behavior specific to a particular brand and use-case. By constantly monitoring user interactions and incorporating feedback, the system 102 delivers a personalized experience tailored to individual users and brand preferences. This personalized approach significantly enhances the user journey by providing targeted and relevant recommendations that address specific user needs and expectations.

Further, the discovery of recommending set of potential courses of actions (e.g., next best actions (NBAs)) using AI models 300C, such as LLMs, represents a significant advancement in conversational AI. By integrating AI models and utilizing active learning methodologies, organizations can leverage AI studios to empower their AI systems with enhanced predictive capabilities. This facilitates personalized and contextually relevant potential courses of actions recommendations, driving customer satisfaction, optimizing decision-making processes, and gaining a competitive edge in the current dynamic and evolving market.

Further, the AI model 300C may discover parameters for recommending set of potential courses of actions. The AI model 300C using the system 102 may acquire and understand user entities within the context of a conversation. This is made possible through the identification and utilization of parameters, which capture the relevant information shared by the user. By leveraging these parameters, the system 102 gains a deeper understanding of the user's preferences, enhancing its conversational capabilities. The system 102 may also include an entity discovery algorithm to recognize commonly used entities such as cities, age groups, fare classes, flight numbers, and the like, and can be configured to recognize business-specific entities from the conversation's messages. Additionally, the algorithm intelligently deduces synonyms and abbreviations for entity values. For example, “NY” is interpreted as “New York,” which is one of the possible values for the NBA city parameter. Furthermore, we select appropriate entity classes mentioned in the NBA repository and pre-fill them, along with the recommended set of potential courses of actions URL.

Furthermore, the entity discovery algorithm may comprehend the hierarchy of entities. This feature proves valuable in situations where the recommended set of potential courses of actions requires broader entity values while the user provides specific information. For instance, if a user mentions a city during the conversation, but the recommending set of potential courses of actions URL requires a country to direct the user to the appropriate URL, the AI can deduce the country from the mentioned city and pre-fill the recommending set of potential courses of actions country parameter accordingly. Another aspect includes an ability to learn user preferences within the capacity to pre-fill context when completing actions related to natural language-based automation. With knowledge gained from the user's preferences, the system 102 may proactively anticipate the context required to successfully execute actions. By pre-filling the necessary context, the system 102 streamlines the user experience, reducing the need for explicit instructions and making the interaction more seamless and efficient. By leveraging these preferences, the system 102 gains the ability to extract more context and pre-fill necessary information for executing actions in the context of recommending set of potential courses of actions. Through these advancements, the system 102 delivers a more personalized, efficient, and accurate conversational experience, raising the standards of AI-powered interactions.

As an illustrative example, consider a scenario where a user previously mentioned in a message that the user consistently prefers flying in the business class. In such a case, the system 102 may utilize this information to intelligently predict the appropriate NBA, such as “book flight”, at any given point during the conversation. To ensure a seamless user experience and optimize the execution of the recommending set of potential courses of actions, additional parameters related to the fare class, specifically set as “business”, are incorporated into the recommending set of potential courses of actions URL. By incorporating the fare class parameter into the recommending set of potential courses of actions URL, the system 102 may effectively communicate the user's preference for booking a flight in the business class to a downstream system such as, but are not limited to, customer relationship management (CRM), internal enterprise systems, travel management system and the like, responsible to fulfill a user request through the search query. This integration of parameters not only streamlines the user experience but also significantly reduces the number of steps the user needs to perform to accomplish their desired task.

Further, with the fare class parameter pre-filled as “business”, the system 102 (e.g., downstream system) may promptly recognize and process the user's preference without requiring the user to manually specify this information repeatedly. As a result, the user is spared the inconvenience of providing redundant details, thereby enhancing their overall experience, and saving valuable time. The integration of additional parameters into the recommended set of potential courses of actions URL showcases an ability of the system 102 to intelligently leverage user preferences for optimizing the execution of tasks. By proactively incorporating specific information, such as the fare class, into the conversation flow, the system 102 may effectively bridge the gap between user intent and downstream system requirements. The intelligent handling of parameters not only improves the efficiency of completing tasks but also enhances the overall conversational experience by reducing the user's cognitive load and eliminating unnecessary steps. Consequently, the inclusion of additional parameters, such as the fare class, within the recommending set of potential courses of actions URL exemplifies how the system 102 enhances the user experience and streamlines task completion. By intelligently predicting the appropriate recommending set of potential courses of actions and pre-filling relevant information, the system 102 minimizes user effort and accelerates the interaction with downstream systems. This intelligent integration of parameters reflects commitment of the system 102 to deliver a seamless, efficient, and user-centric conversational AI experience.]

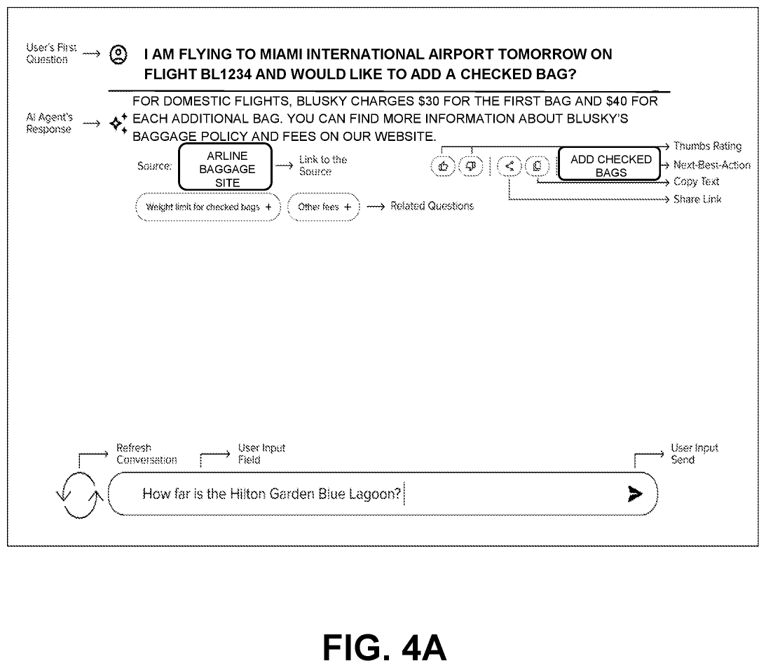

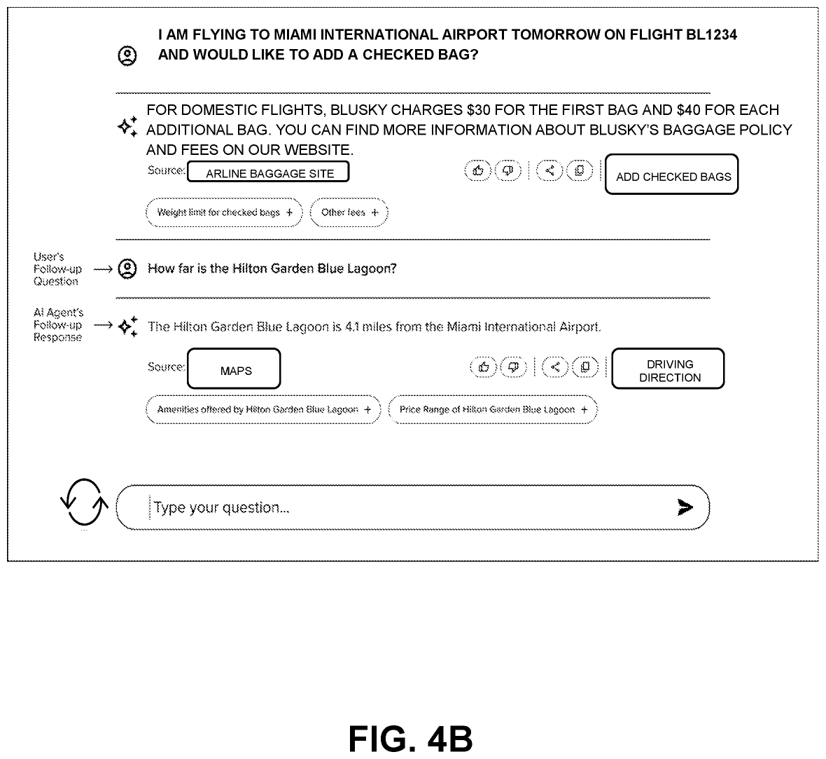

FIGS. 4A and 4B illustrate exemplary schematic diagram representations of scenarios for dynamically recommending a set of potential courses of actions for a user, within a search query, in accordance with an embodiment of the present disclosure. The system 102 may provide, through the user device 106 to the user, a search web page. When the user initiates a search by providing a search query, the system 102 may use generative and other AI models to generate a short response from the knowledge base indexed with AI generated embeddings. The search may be a single short search as shown in FIG. 4A or a follow up search within the context of user search as shown in FIG. 4B. When search results are presented to the search user shown in FIG. 4A, the search graphical user interface (GUI) may also provide buttons to indicate whether the user liked the short response, search results, including relevant links, related links, recommending set of potential courses of actions application presented. When search results are presented to the search user, the user may click on relevant and other related links.

For example, consider a user search query as “Hi, I'm planning to travel to Chicago from New York with my spouse tomorrow”. The system 102 may responds: <<AI generates the flight options from user's location to Chicago>>. Further, the recommended set of potential courses of actions is “Book Flights”. Recommended parameters are “number of travelers=2, source: New York, Destination=Chicago. In the above example, the system 102 may discover and extract three crucial parameters from the conversation context. These parameters include the number of travelers, the source location (New York), and the destination (Chicago). This discovery is made possible by the AI's contextual comprehension and analysis of the user's statement, where the user explicitly mentions traveling with their spouse and provides the specific cities of origin and destination. By accurately identifying and capturing these parameters, the system 102 provides the user with specific and relevant information tailored to their intent. Instead of having to familiarize themselves with a new application interface or starting the flight booking process from scratch, the user can benefit from the AI's comprehension of their preferences and seamlessly receive the required details.

For example, not all recommended set of potential courses of actions is the same, depending on the user persona (employee vs client of the enterprise) and whether the user is logged in, the recommended set of potential courses of actions (NBAs) available to the user may be different. The recommended set of potential courses of actions can be either auto executable or user triggered. In the case of the recommended set of potential courses of actions are auto executed by the system 102 to retrieve the information to supplement the generated response. As for user triggered recommended set of potential courses of actions, the system 102 may identify the recommended set of potential courses of actions and present to the user to action upon. Both types of recommended set of potential courses of actions are auto discovered from the database 104.

The different types of recommended set of potential courses of actions may include, but not limited to one or more recommending set of potential courses of actions without the one or more query parameters, one or more recommending set of potential courses of actions with the one or more query parameters, a one or more recommending set of potential courses of actions with or without deep integration parameters, one or more recommending set of potential courses of actions driven using a plurality of entry points based on the one or more search queries, and the like. Consider recommended set of potential courses of actions without parameters. For example, the user search query may be “I am flying to Miami tomorrow and would like to check-in now?”. The system 102 responds as “general check-in info displayed”. The recommended set of potential courses of actions may be “flight check-in, application: flight check-in”, params are “none required”. Another example includes a user search query “Hi, what are the places to visit?”. The system 102 responds as “AI recommended a list of attractions”. The recommended set of potential courses of actions “flight booking. Application: Flight Booking; Parameters: None”. In the above example, the system 102 understands that the user is interested to know places to visit in Miami, hence, it is likely that the user may be interested in booking flights to Miami.

Consider, another example in which a user query may be “I am traveling with a kid, can I carry strollers in the cabin? It is a large one”. The system may respond as “large items need to be booked separately”. The recommended set of potential courses of actions may be “book over-sized items”, application may be “baggage booking, parameters: none”. In the above example, the system 102 learns that strollers are large items, and users may be interested in booking oversize baggage items.

Consider, a scenario of recommended set of potential courses of actions with parameters. For example, the user search query may be “I am traveling to Paris tomorrow for two days, is flight BL1234 on time?”. The system 102 may respond as “Yes, based on the latest flight status it's expected to arrive on the scheduled time at 1700 GMT”. The recommended set of potential courses of actions is “car rentals, application: flight status, parameters: booking date=tomorrow, duration=2 days”. In the above interaction, the system 102 recommends to rent-a-car as the user is traveling to Paris for two days, he might be interested in renting a car for two days. In another example, the user search query may be “I'm not planning to carry any jackets with me, would that be, okay?”. The system 102 may respond “usually, it is recommended to carry the woolen with you as the lowest temperature for next 15 days could reach up to −1 C in the evening. However, the next few days could be very pleasant in the daytime”. The recommended set of potential courses of actions may be “view Attractions; Application: List Attraction, Parameters: weather=sunny, city=Paris”. In the second interaction, the system 102 understood that the user is not carrying a jacket, hence, it could be helpful to show attractions for a sunny day in Paris.

Further, consider a scenario of generic recommended set of potential courses of actions with or without deep integration parameters. For example, consider a user search query as “How far is the Hilton Garden Blue lagoon from Miami international airport?”. The system 102 may respond as “auto-execute recommended set of potential courses of actions <<Summary generated by generative AI based on details fetched from maps API>>. A sample generated response may be “The H Garden Blue Lagoon is 4.1 miles from the Miami International Airport”. The user triggered recommended set of potential courses of actions may be “driving directions. Application: maps”, parameters are “start and end destination”. For example, the user search query may be “what is the weather like in Miami tomorrow afternoon?”, and the system 102 may respond as “auto-execute recommended set of potential courses of actions <<Summary generated by Generative AI based on details fetched from weather.com API>>”. The user triggered recommended set of potential courses of actions may be “weather for next 5 days. application: weather.com application programming interface (API); Params: destination city and day”.

Consider, a scenario of one or more recommending set of potential courses of actions driven using a plurality of entry points based on the one or more search queries. The recommended set of potential courses of actions driven by user query and not one to one with applications. Building on example from of recommended set of potential courses of actions with parameters from above, the same flight booking application is called, however, it is called with different entry points based on the user query. For example, the user search query may be “I am flying to Miami tomorrow on flight MI1234 and would like to add a checked bag?”. The system 102 responds as “user is shown cost of checked bags for the flight #provided by user”. The recommended set of potential courses of actions may be “add checked bags. application: flight booking adds checked bag”, and the parameters may be destination, flight date, flight number, number of bags.

In another example, the user search query may be “I am flying to Miami tomorrow on flight MI1234 and would like to pre-order a meal?”. The system 102 may response as “user is shown meal options and cost for the flight #provided by user. The recommended set of potential courses of actions may be “pre-order meal. application: flight booking pre-order meal”, and parameters may be destination, flight date, flight number.

In another aspect, consider a scenario of up-sell recommending set of potential courses of actions for the user vs. x-sell recommending set of potential courses of actions. The traditional approaches to up-sell/x-sell products require a detailed understanding of the user's behavior and past system interactions (browsing, buying, and so on). The system 102 may present users with the up-sell recommending set of potential courses of actions and/or the x-sell recommending set of potential courses of actions based on the user's intent. The recommended set of potential courses of actions presented are in the current context of user search and not static offers, thereby having a higher propensity of user engagement. For example, consider a user search query as “I fly often and would request an upgrade for my upcoming flight to Miami from NYC?”. The system 102 may respond as “If you sign up for airline credit card today, you will get 65000 bonus signup points and also a free seat upgrade for your upcoming flight”. The recommended set of potential courses of actions may be “sign-up for credit card. application: credit card application; parameters: application type: new credit card user signup”. In this scenario the system 102 may understand from users' intent that they would like to get a free seat upgrade and also that the user is a frequent customer of the airline. Hence, the system 102 may x-sell a credit card product while also meeting the customers' criteria of getting a free seat upgrade. In another example, consider the user is signed-in to their profile with the airline. The user search query may be “I would like to check in for my upcoming flight to Miami from NYC?”. The system 102 may respond as “Did you know that as an airline credit card holder, you can redeem your accumulated points or pay $100 to get a business class upgrade for this flight?”. Further, the recommended set of potential courses of actions may be “redeem points to upgrade. application: flight booking seat upgrade, parameters: user profile”. In this scenario the system 102 may up-sell based on the intent and user profile.

Other capabilities enabled via recommended set of potential courses of actions may include, but not limited to, A/B testing and measurement, evaluate out the different version of the application, incremental re-routing of user traffic, user journey mapping, and the like. The A/B testing may be essentially an experiment where two or more variants of a page are shown to users at random, and statistical analysis is used to determine which variation performs better for a given conversion goal. Further, the recommended set of potential courses of actions mechanism can be used to evaluate out the different version of the application to measure which route produces better engagement from the customers that click on the recommended set of potential courses of actions presented. The incremental re-routing of user traffic may be based on the above test, recommended set of potential courses of actions can be set up to auto-route incoming user traffic to the preferred application. The user journey mapping may include recommended set of potential courses of actions that can be used to develop an understanding of how the clients interact with the various enterprise applications.

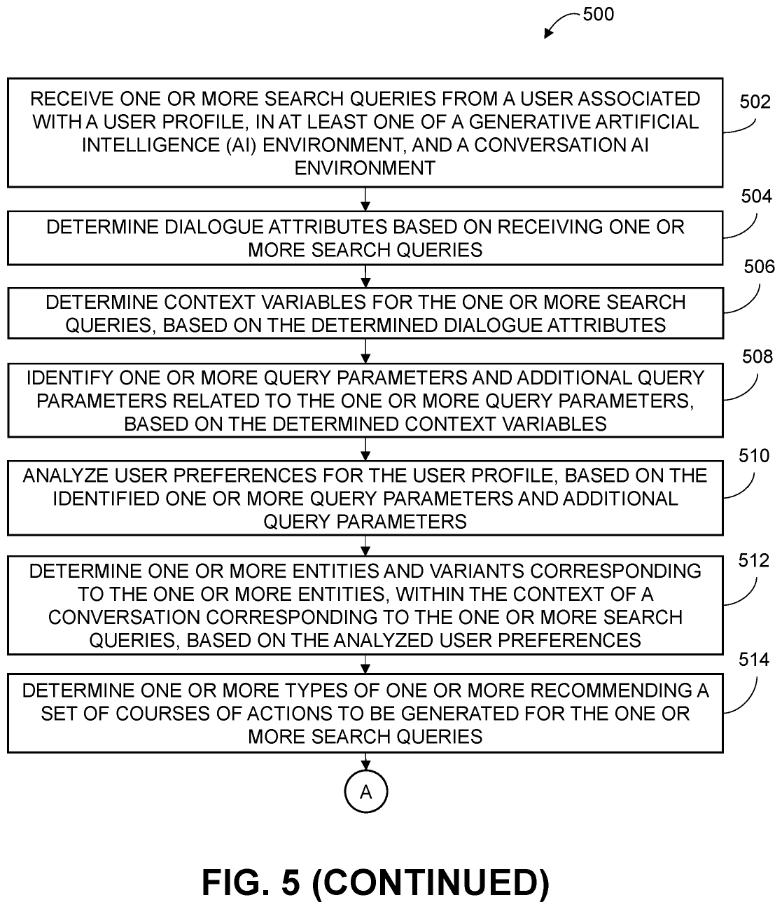

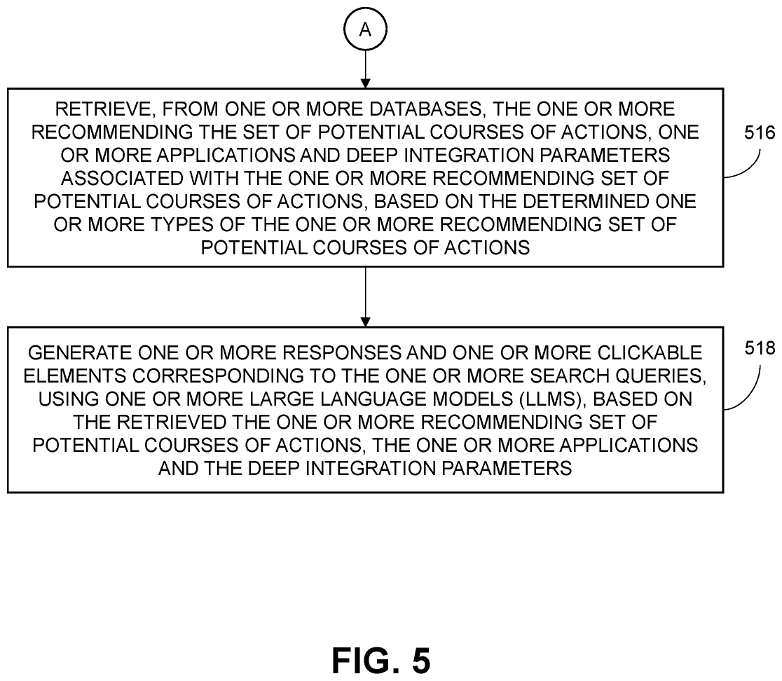

FIG. 5 illustrates a flow chart depicting a method 500 of dynamically recommending set of potential courses of actions for a user, within a search query, in accordance with the embodiment of the present disclosure.

At block 502, the method 500 may include receiving, by one or more hardware processors 110, one or more search queries from a user associated with a user profile, in at least one of a generative artificial intelligence (AI) environment, and a conversation AI environment.

At block 504, the method 500 may include determining, by the one or more hardware processors 110, dialogue attributes based on receiving one or more search queries.

At block 506, the method 500 may include determining, by the one or more hardware processors 110, context variables for the one or more search queries, based on the determined dialogue attributes.

At block 508, the method 500 may include identifying, by the one or more hardware processors 110, one or more query parameters and additional query parameters related to the one or more query parameters, based on the determined context variables.

At block 510, the method 500 may include analyzing, by the one or more hardware processors 110, user preferences for the user profile, based on the identified one or more query parameters and additional query parameters.

At block 512, the method 500 may include determining, by the one or more hardware processors 110, one or more entities and variants corresponding to the one or more entities, within the context of a conversation corresponding to the one or more search queries, based on the analyzed user preferences.

At block 514, the method 500 may include determining, by the one or more hardware processors 110, one or more types of one or more recommending a set of potential courses of actions to be generated for the one or more search queries.

At block 516, the method 500 may include retrieving, by the one or more hardware processors 110, from one or more databases 104, the one or more recommending set of potential courses of actions, one or more applications and deep integration parameters associated with the one or more recommending set of potential courses of actions, based on the determined one or more types of the one or more recommending set of potential courses of actions.

At block 518, the method 500 may include generating, by the one or more hardware processors 110, one or more responses and one or more clickable elements corresponding to the one or more search queries, using one or more large language models (LLMs), based on the retrieved the one or more recommending set of potential courses of actions for the user, the one or more applications and the deep integration parameters. The LLMs are associated with at least one of a generative artificial intelligence (AI) environment, and a conversation AI environment.

The method 500 may be implemented in any suitable hardware, software, firmware, or combination thereof. The order in which the method 500 is described is not intended to be construed as a limitation, and any number of the described method blocks may be combined or otherwise performed in any order to implement the method 500 or an alternate method. Additionally, individual blocks may be deleted from the method 500 without departing from the spirit and scope of the present disclosure described herein. Furthermore, the method 500 may be implemented in any suitable hardware, software, firmware, or a combination thereof, that exists in the related art or that is later developed. The method 500 describes, without limitation, the implementation of the system 102. A person of skill in the art will understand that method 500 may be modified appropriately for implementation in various manners without departing from the scope and spirit of the disclosure.

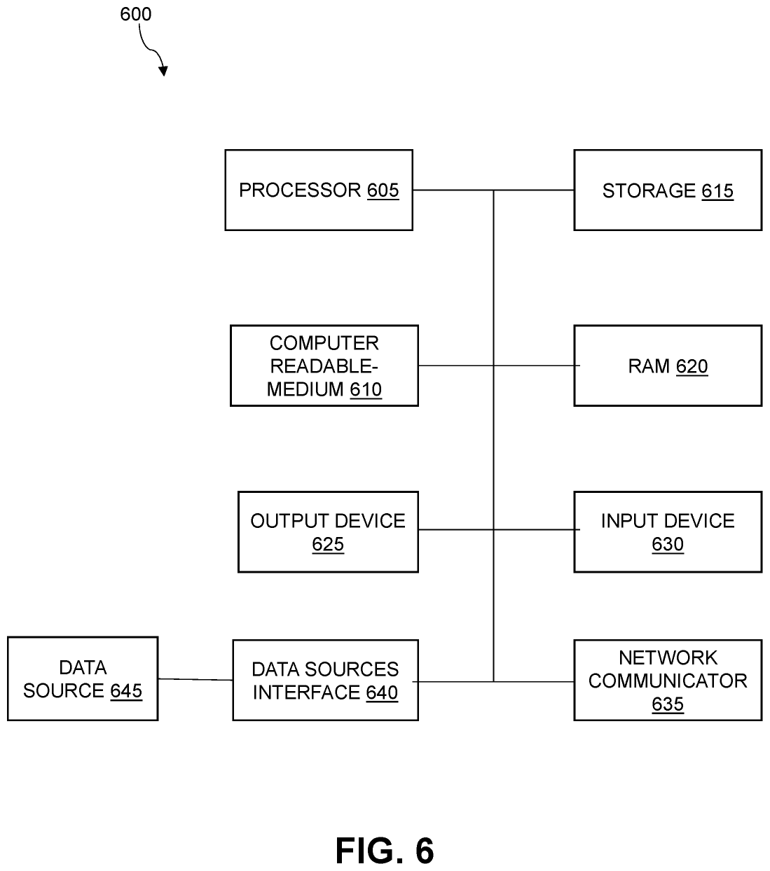

FIG. 6 illustrates an exemplary block diagram representation of a hardware platform 600 for implementation of the disclosed system 102, according to an example embodiment of the present disclosure. For the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of the hardware platform 600. As illustrated, the hardware platform 600 may include additional components not shown, and some of the components described may be removed and/or modified. For example, a computer system with multiple GPUs may be located on external-cloud platforms including Amazon Web Services, internal corporate cloud computing clusters, or organizational computing resources.

The hardware platform 600 may be a computer system such as the system 102 that may be used with the embodiments described herein. The computer system may represent a computational platform that includes components that may be in a server or another computer system. The computer system may be executed by the processor 605 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the processor 605 that executes software instructions or code stored on a non-transitory computer-readable storage medium 610 to perform methods of the present disclosure. The software code includes, for example, instructions to gather data and analyze the data. For example, the plurality of modules 114 includes a query receiving module 206, a dialogue determining module 208, a context determining module 210, a parameter identifying module 212, an preference analyzing module 214, an entity determining module 216, a type determining module 218, a sequence retrieving module 220, a interaction generating module 222, a rate tracking module 224, a loop creating module 226, a pattern modifying module 228, a user preference determining module 230, an context anticipating module 232, and a context suggesting module 234.

The instructions on the computer-readable storage medium 610 are read and stored the instructions in storage 615 or random-access memory (RAM). The storage 615 may provide a space for keeping static data where at least some instructions could be stored for later execution. The stored instructions may be further compiled to generate other representations of the instructions and dynamically stored in the RAM such as RAM 620. The processor 605 may read instructions from the RAM 620 and perform actions as instructed.

The computer system may further include the output device 625 to provide at least some of the results of the execution as output including, but not limited to, visual information to users, such as external agents. The output device 625 may include a display on computing devices and virtual reality glasses. For example, the display may be a mobile phone screen or a laptop screen. GUIs and/or text may be presented as an output on the display screen. The computer system may further include an input device 630 to provide a user or another device with mechanisms for entering data and/or otherwise interacting with the computer system. The input device 630 may include, for example, a keyboard, a keypad, a mouse, or a touchscreen. Each of these output devices 625 and input device 630 may be joined by one or more additional peripherals. For example, the output device 625 may be used to display the results such as bot responses by the executable chatbot.

A network communicator 635 may be provided to connect the computer system to a network and in turn to other devices connected to the network including other clients, servers, data stores, and interfaces, for example. A network communicator 635 may include, for example, a network adapter such as a LAN adapter or a wireless adapter. The computer system may include a data sources interface 640 to access the data source 645. The data source 645 may be an information resource. As an example, a database of exceptions and rules may be provided as the data source 645. Moreover, knowledge repositories and curated data may be other examples of the data source 645.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A computer-implemented system for dynamically recommending a set of potential courses of actions for a user, within a search query, the computer-implemented system comprising:
one or more hardware processors;
a memory coupled to the one or more hardware processors, wherein the memory comprises a plurality of modules in form of programmable instructions executable by the one or more hardware processors, wherein the plurality of modules comprises:
a query receiving module configured to receive one or more search queries from a user associated with a user profile, in at least one of a generative artificial intelligence (AI) environment, and a conversation AI environment;
a dialogue determining module configured to determine dialogue attributes based on receiving one or more search queries;
a context determining module configured to determine context variables for the one or more search queries, based on the determined dialogue attributes;
a parameter identifying module configured to identify one or more query parameters and additional query parameters related to the one or more query parameters, based on the determined context variables;
a preference analyzing module configured to analyze user preferences for the user profile, based on the identified one or more query parameters and additional query parameters;
an entity determining module configured to determine one or more entities and variants corresponding to the one or more entities, within the context of a conversation corresponding to the one or more search queries, based on the analyzed user preferences;
a type determining module configured to determine one or more types of one or more recommending a set of potential courses of actions to be generated for the one or more search queries;
a sequence retrieving module configured to retrieve, from one or more databases, the one or more recommending the set of potential courses of actions, one or more applications and deep integration parameters associated with the one or more recommending the set of potential courses of actions, based on the determined one or more types of the one or more recommending the set of potential courses of actions; and
an interaction generating module configured to generate one or more responses and one or more clickable elements corresponding to the one or more search queries, using one or more large language models (LLMs), based on the retrieved the one or more recommending the set of potential courses of actions for the user, the one or more applications and the deep integration parameters, wherein the LLMs are associated with at least one of a generative artificial intelligence (AI) environment, and a conversation AI environment.

2. The computer-implemented system of claim 1, wherein the plurality of modules further comprises:
a rate tracking module configured to track user click-through rates on the generated one or more responses and one or more clickable elements corresponding to the one or more search queries;
a loop creating module configured to create a feedback loop corresponding to the tracked user click-through rates to influence the one or more LLMs to reinforce and generate similar one or more responses and one or more clickable elements corresponding to similar one or more search queries; and
a pattern modifying module configured to modify the one or more LLMs to both seasonal patterns and user behavior patterns tracked through user click-through rates for the one or more search queries, based on the created feedback loop.

3. The computer-implemented system of claim 1, wherein for determining the one or more types of one or more recommending the set of potential courses of actions, the type determining module is further configured to:
determine at least one of an auto-executed type one or more recommending the set of potential courses of actions and a user triggered type of one or more recommending the set of potential courses of actions;
retrieve information from the one or more databases to supplement the generated one or more responses, when the determined one or more types corresponds to the auto-executed type one or more recommending the set of potential courses of actions; and
identify from the one or more databases the one or more recommending the set of potential courses of actions to display to the user for required action, when the determined one or more types corresponds to the user triggered type one or more recommending the set of potential courses of actions.

4. The computer-implemented system of claim 1, wherein the plurality of modules further comprises:
a user preference determining module configured to determine one or more user preferences from an action on the one or more clickable elements and the one or more search queries;
a context anticipating module configured to anticipate one or more contexts required to execute actions on the one or more clickable elements and the one or more search queries; and
a context suggesting module configured to suggest one or more contexts when completing actions related to natural language on the one or more clickable elements and the one or more search queries.

5. The computer-implemented system of claim 1, wherein the plurality of modules further comprises:
a sell recommending module configured to recommend at least on one of an up-sell recommending the set of potential courses of actions and a x-sell recommending the set of potential courses of actions, based on a user intent in the determined context variables for the one or more search queries.

6. The computer-implemented system of claim 1, wherein the dialogue attributes comprise at least one of a current search query, a historical conversation, and additional interactions within a plurality of conversations.

7. The computer-implemented system of claim 1, wherein the variants corresponding to the one or more entities comprises at least one of synonyms of the one or more entities, abbreviations of the one or more entities, and a hierarchy of the one or more entities.

8. The computer-implemented system of claim 1, wherein the one or more types of one or more recommending the set of potential courses of actions comprises at least one of a one or more recommending the set of potential courses of actions without the one or more query parameters, a one or more recommending the set of potential courses of actions with the one or more query parameters, a one or more recommending the set of potential courses of actions with or without deep integration parameters, and a one or more recommending the set of potential courses of actions driven using a plurality of entry points based on the one or more search queries.

9. The computer-implemented system of claim 1, wherein the one or more applications retrieved from one or more databases based on at least one of an application name, application description, application meta-data, application identifier, display name of the one or more applications, short textual description, a universal resource locator (URL) of the one or more applications, and a list of parameters corresponding to application context.

10. A computer-implemented method for dynamically recommending a set of potential courses of actions for a user, within a search query, the computer-implemented method comprising:
receiving, by one or more hardware processors, one or more search queries from a user associated with a user profile, in at least one of a generative artificial intelligence (AI) environment, and a conversation AI environment;
determining, by the one or more hardware processors, dialogue attributes based on receiving one or more search queries;
determining, by the one or more hardware processors, context variables for the one or more search queries, based on the determined dialogue attributes;
identifying, by the one or more hardware processors, one or more query parameters and additional query parameters related to the one or more query parameters, based on the determined context variables;
analyzing, by the one or more hardware processors, user preferences for the user profile, based on the identified one or more query parameters and additional query parameters;
determining, by the one or more hardware processors, one or more entities and variants corresponding to the one or more entities, within the context of a conversation corresponding to the one or more search queries, based on the analyzed user preferences;
determining, by the one or more hardware processors, one or more types of one or more recommending a set of potential courses of actions to be generated for the one or more search queries;
retrieving, by the one or more hardware processors, from one or more databases, the one or more recommending the set of potential courses of actions, one or more applications and deep integration parameters associated with the one or more recommending the set of potential courses of actions, based on the determined one or more types of the one or more recommending the set of potential courses of actions; and
generating, by the one or more hardware processors, one or more responses and one or more clickable elements corresponding to the one or more search queries, using one or more large language models (LLMs), based on the retrieved the one or more recommending the set of potential courses of actions for the user, the one or more applications and the deep integration parameters, wherein the LLMs are associated with at least one of a generative artificial intelligence (AI) environment, and a conversation AI environment.

11. The computer-implemented method of claim 10 further comprising:
tracking, by the one or more hardware processors, user click-through rates on the generated one or more responses and one or more clickable elements corresponding to the one or more search queries;
creating, by the one or more hardware processors, a feedback loop corresponding to the tracked user click-through rates to influence the one or more LLMs to reinforce and generate similar one or more responses and one or more clickable elements corresponding to similar one or more search queries; and
modifying, by the one or more hardware processors, the one or more LLMs to both seasonal patterns and user behavior patterns tracked through user click-through rates for the one or more search queries, based on the created feedback loop.

12. The computer-implemented method of claim 10, wherein determining the one or more types of one or more recommending the set of potential courses of actions, further comprises:
determining, by the one or more hardware processors, at least one of an auto-executed type one or more recommending the set of potential courses of actions and a user triggered type of one or more recommending the set of potential courses of actions;
retrieving, by the one or more hardware processors, information from the one or more databases to supplement the generated one or more responses, when the determined one or more types corresponds to the auto-executed type one or more recommending the set of potential courses of actions; and
identifying, by the one or more hardware processors, from the one or more databases the one or more recommending the set of potential courses of actions to display to the user for required action, when the determined one or more types corresponds to the user triggered type one or more recommending course of action sequences.

13. The computer-implemented method of claim 10 further comprising:
determining, by the one or more hardware processors, one or more user preferences from an action on the one or more clickable elements and the one or more search queries;
anticipating, by the one or more hardware processors, one or more contexts required to execute actions on the one or more clickable elements and the one or more search queries; and
suggesting, by the one or more hardware processors, one or more contexts when completing actions related to natural language on the one or more clickable elements and the one or more search queries.

14. The computer-implemented method of claim 10 further comprising:
recommending, by the one or more hardware processors, at least on one of an up-sell recommending the set of potential courses of actions and a x-sell recommending the set of potential courses of actions, based on a user intent in the determined context variables for the one or more search queries.

15. The computer-implemented method of claim 10, wherein the dialogue attributes comprise at least one of a current search query, a historical conversation, and additional interactions within a plurality of conversations.

16. The computer-implemented method of claim 10, wherein the variants corresponding to the one or more entities comprises at least one of synonyms of the one or more entities, abbreviations of the one or more entities, and hierarchy of the one or more entities.

17. The computer-implemented method of claim 10, wherein the one or more types of one or more recommending the set of potential courses of actions comprises at least one of a one or more recommending the set of potential courses of actions without the one or more query parameters, a one or more recommending the set of potential courses of actions with the one or more query parameters, a one or more recommending the set of potential courses of actions with or without deep integration parameters, and a one or more recommending the set of potential courses of actions driven using a plurality of entry points based on the one or more search queries.

18. The computer-implemented method of claim 10, wherein the one or more applications retrieved from one or more databases based on at least one of an application name, application description, application meta-data, application identifier, display name of the one or more applications, short textual description, a universal resource locator (URL) of the one or more applications, and a list of parameters corresponding to application context.

19. A non-transitory computer-readable storage medium having programmable instructions stored therein, that when executed by one or more hardware processors, cause the one or more hardware processors to:
receive one or more search queries from a user associated with a user profile, in at least one of a generative artificial intelligence (AI) environment, and a conversation AI environment;
determine dialogue attributes based on receiving one or more search queries;
determine context variables for the one or more search queries, based on the determined dialogue attributes;
identify one or more query parameters and additional query parameters related to the one or more query parameters, based on the determined context variables;
analyze user preferences for the user profile, based on the identified one or more query parameters and additional query parameters;
determine one or more entities and variants corresponding to the one or more entities, within the context of a conversation corresponding to the one or more search queries, based on the analyzed user preferences;
determine one or more types of one or more recommending a set of potential courses of actions to be generated for the one or more search queries;
retrieve, from one or more databases, the one or more recommending the set of potential courses of actions, one or more applications and deep integration parameters associated with the one or more recommending the set of potential courses of actions, based on the determined one or more types of the one or more recommending the set of potential courses of actions; and
generate one or more responses and one or more clickable elements corresponding to the one or more search queries, using one or more large language models (LLMs), based on the retrieved the one or more recommending the set of potential courses of actions for the user, the one or more applications and the deep integration parameters, wherein the LLMs are associated with at least one of a generative artificial intelligence (AI) environment, and a conversation AI environment.

20. The non-transitory computer-readable storage medium of claim 19, wherein the one or more hardware processors are further configured to:
track user click-through rates on the generated one or more responses and one or more clickable elements corresponding to the one or more search queries;
create a feedback loop corresponding to the tracked user click-through rates to influence the one or more LLMs to reinforce and generate similar one or more responses and one or more clickable elements corresponding to similar one or more search queries; and
modify the one or more LLMs to both seasonal patterns and user behavior patterns tracked through user click-through rates for the one or more search queries, based on the created feedback loop.
